(19) United States
(12) Patent Application Publication
(10) Pub. No.: US 2008/0122388 A1
(43) Pub. Date: May 29, 2008

(54) Illumination device and method of controlling the lamp unit thereof

(75) Inventors: Ping-Chin Kuo, Taoyuan County (TW); Yung-Yi Hsu, Taipei County (TW)

Correspondence Address: BIRCH STEWART KOLASCH & BIRCH, PO BOX 747, FALLS CHURCH, VA, 22040-0747, US

(73) Assignee: BENQ Corporation

(21) Appl. No.: 11/812,741

(22) Filed: Jun. 21, 2007

(30) Foreign Application Priority Data
Jun. 22, 2006 (TW) 95122456

(51) Int. Cl. H05B 41/39

(52) U.S. Cl. 315/308

(57) ABSTRACT

An illumination device comprises a lamp unit, a control unit, and a continuous mode inverter. The control unit receives a command signal to set the target brightness of the lamp unit and generates an inverter control signal. The inverter control signal is a continuous mode pulse signal when the target brightness is in a first range of target brightness, and is a burst mode pulse signal when the target brightness is in a second range of target brightness. The continuous mode inverter generates a lamp unit control signal based on the inverter control signal. The lamp unit control signal is a continuous mode AC signal when the inverter control signal is the continuous mode pulse signal, and is a burst mode AC signal when the inverter control signal is the burst mode pulse signal.

### BACKGROUND OF THE INVENTION

1. Field of the Invention

The invention relates to illumination devices and more particularly to methods for controlling lamp units of an illumination device.

2. Description of the Related Art

A backlight module is a crucial component in Liquid Crystal Display (LCD) panels. A backlight module illuminates liquid crystal molecules, which do not emit light, to display images on an LCD panel.

Conventional illumination devices, utilized as backlight modules, include continuous mode illumination devices and conventional burst mode illumination devices. FIG. 1A is a block diagram of a conventional continuous mode illumination device 100, which comprises a conventional control unit 102, a conventional continuous mode inverter 104, and a lamp unit 106. The conventional control unit 102 generates an inverter control signal 110 according to a command signal 108 that sets a target brightness of the lamp unit 106. A conventional continuous mode inverter 104 generates a lamp unit control signal 112 to control the brightness of the lamp unit 106 to approach the target brightness based on the inverter control signal 110 and a feedback signal 112 from the lamp unit 106. The conventional continuous mode illumination device 100 comprises conventional continuous mode inverter 104. The conventional continuous mode inverter 104 receives a DC voltage Vcc and the inverter control signal 110 (which can be a DC voltage signal), and generates the lamp unit control signal 112 for the lamp unit 106. The lamp unit control signal 112 may be an AC current or voltage signal. FIG. 1B illustrates the relationship between the inverter control signal 110 and the lamp unit control signal 112. The amplitude of the lamp unit control signal 112 increases with the inverter control signal 110. The brightness of the lamp unit 106 increases with the amplitude of the lamp unit control signal 112. As shown in FIG. 1B, the inverter control signal 110 is a DC voltage signal, and the lamp unit control signal 112 is a continuous AC signal. In the conventional continuous mode illumination device 100, the circuit of the conventional continuous mode inverter 104 is simple and cheap. The drawback of the conventional continuous mode illumination device 100 is that the brightness of the lamp unit 106 cannot be held to a very low level.

FIG. 2A is a block diagram of a conventional burst mode illumination device 200, which has a wide brightness range. In the conventional burst mode illumination device 200, a conventional burst mode inverter 204 is substituted for the conventional continuous mode inverter 104. FIG. 2B illustrates the relationship between an inverter control signal 210 and a lamp unit control signal 212. The inverter control signal 210 is a DC voltage signal. The conventional burst mode inverter 204 receives a DC voltage Vcc and the inverter control signal 210, and generates the lamp unit control signal 212. The lamp unit control signal 212 is a burst mode AC signal (as shown in FIG. 2B). The lower the inverter control signal 210, the longer the breaks of the lamp unit control signal 212. The brightness of the lamp unit 206 decreases when the break length increases. The brightness of the lamp unit 206 can be controlled to a very low level because the lamp unit control signal 212 is a burst mode AC signal. The drawback of the conventional burst mode illumination device 200 is that the conventional burst mode inverter 204 is more expensive than the conventional continuous mode inverter 104.

Thus, an inexpensive illumination device capable of controlling a wide range of brightness is desirable.

### BRIEF SUMMARY OF THE INVENTION

Inexpensive illumination devices capable of a controlling a wide range of brightness.

An exemplary embodiment of an illumination device comprises a lamp unit, a control unit, and a continuous mode inverter. A target brightness of the lamp unit is determined by a command signal. The control unit generates an inverter control signal for the continuous mode inverter based on the command signal. When the target brightness is greater than a threshold value, the inverter control signal of the continuous mode inverter is a continuous mode pulse signal, the duty cycle of which increases with the target brightness. When the target brightness is lower than the threshold value, the inverter control signal of the continuous mode inverter is a burst mode pulse signal. The lower the target brightness, the longer the breaks of the burst mode pulse signal. The continuous mode inverter receives a DC voltage Vcc and generates a lamp unit control signal based on the inverter control signal of the continuous mode inverter. The brightness of the lamp unit is controlled by the lamp unit control signal. When the inverter control signal of the continuous mode inverter is a continuous mode pulse signal, the lamp unit control signal is a continuous mode AC signal. The amplitude of the lamp unit control signal increases with the duty cycle of the inverter control signal of the continuous mode inverter. The brightness of the lamp unit increases with the amplitude of the amplitude of the lamp unit control signal. When the inverter control signal of the continuous mode inverter is a burst mode pulse signal, the lamp unit control signal is a burst mode AC signal. The break length of the lamp unit control signal increases with abridgement of pulses in the inverter control signal of the continuous mode inverter. The brightness of the lamp unit decreases when the break length of the lamp unit control signal increases.

When the command signal sets the lamp unit to full brightness, the duty cycle of the inverter control signal of the continuous mode inverter is 100%. The threshold value may be set to represent half the full brightness. The lamp unit control signal maybe an AC voltage and current signal. The illumination device can be implemented as a backlight module of an LCD panel.

Methods for controlling lamp units are provided. An inverter control signal is generated based on a command signal. The target brightness of the lamp unit is set by the command signal. When the target brightness is greater than a threshold value, the inverter control signal is a continuous mode pulse signal. The greater the target brightness, the longer the duty cycle of the inverter control signal. When the target brightness is less than the threshold value, the inverter control signal is a burst mode pulse signal. The greater the target brightness, the more pulses are omitted from the inverter control signal. A lamp unit control signal is generated to control the brightness of the lamp unit based on the inverter control signal. When the inverter control signal of the continuous mode inverter is a continuous mode pulse signal, the lamp unit control signal is a continuous mode AC signal the amplitude of which increases with the duty cycle of the continuous mode pulse signal. The brightness of the lamp unit increases with the amplitude of the lamp unit control signal. When the inverter control signal of the continuous mode inverter is a burst mode pulse signal, the lamp unit control signal is a burst mode AC signal. The more pulses are omitted from the inverter control signal, the longer the break length of the lamp unit control signal. The brightness of the lamp unit decreases when the break length of the lamp unit control signal increases.

### BRIEF DESCRIPTION OF THE DRAWINGS

The invention can be more fully understood by reading the subsequent detailed description and examples with references made to the accompanying drawings, wherein:

FIG. 1A is a block diagram of a conventional continuous mode illumination device;

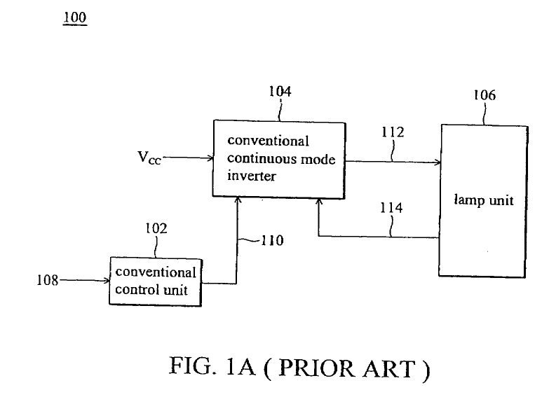

FIG. 1B illustrates the relationship between the inverter control signal 110 and the lamp unit control signal 112;

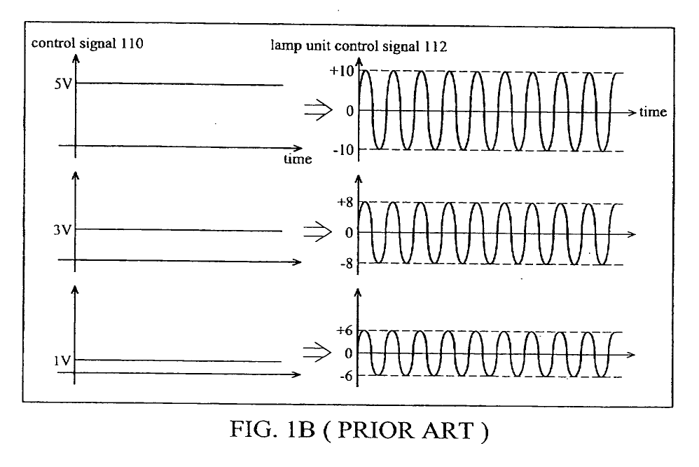

FIG. 2A is a block diagram of a conventional burst mode illumination device;

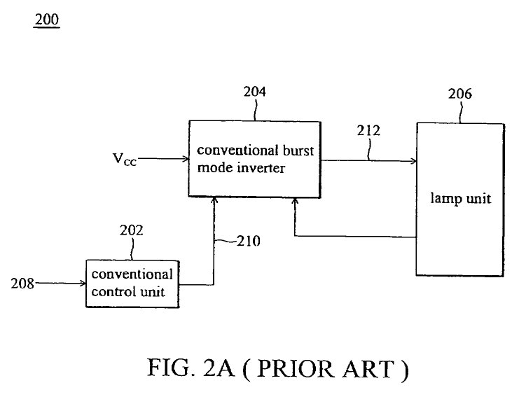

FIG. 2B illustrates the relationship between an inverter control signal 210 and a lamp unit control signal 212;

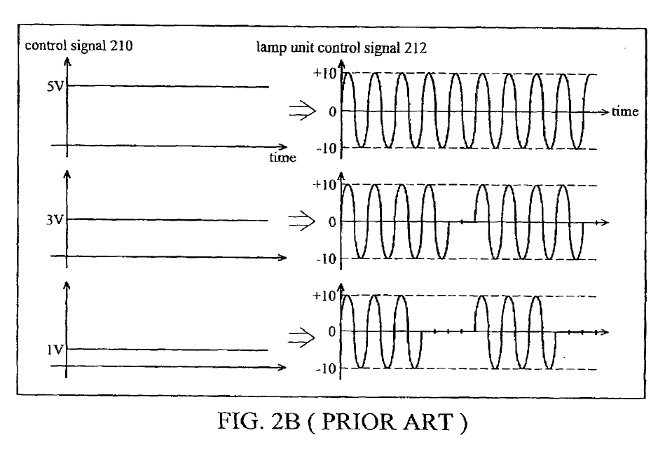

FIG. 3A is a block diagram of an embodiment of this invention; and

FIG. 3B illustrates the relationship between the command signal 308, the inverter control signal 310 and the lamp unit control signal 312.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

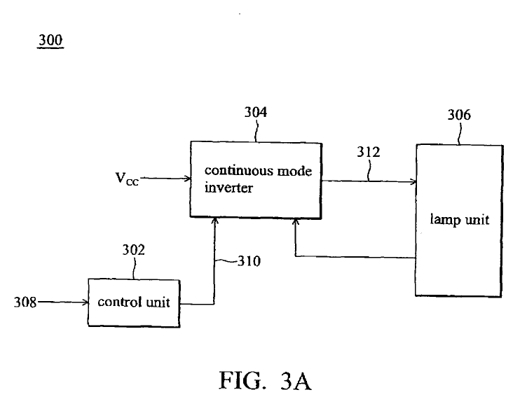

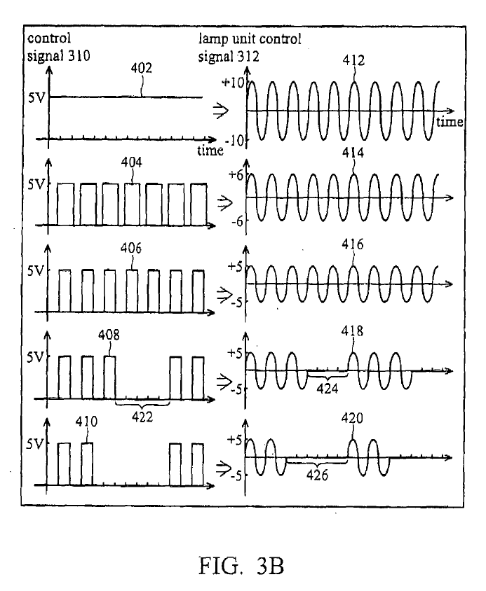

FIG. 3A is a block diagram of an embodiment of the invention. An illumination device 300 comprises a novel continuous mode inverter 304 the circuit of which is simple and cheap (such as the conventional continuous mode inverter 104). The illumination device 300 further comprises a lamp unit 306, a control unit 302. The control unit 302 generates an inverter control signal 310 for the continuous mode inverter 304 based on a command signal 308. The target brightness of the lamp unit 306 is set by the command signal 308. The continuous mode inverter 304 receives a DC voltage Vcc, and generates a lamp unit control signal 312 based on the inverter control signal 310. The brightness of the lamp unit 306 is controlled by the lamp unit control signal 312. The continuous mode inverter 304 may receive a DC current signal to substitute for the DC voltage Vcc. The command signal 308 may be set as 100% to set the lamp unit 306 to full brightness. The command signal may be set as 0% to set the lamp unit 306 to the minimum brightness. The lamp unit control signal 312 may be an AC voltage or current signal.

The control unit 302 further provides a threshold value which is set as 50% in this embodiment. When the command signal 308 sets the target brightness to be greater than the threshold value (50%), the target brightness of the lamp unit 306 is greater than half the full brightness and belongs to a first range of target brightness. The inverter control signal 310 generated by the control unit 302 is a continuous mode pulse signal the duty cycle of which increases with the command signal 308. When the command signal 308 sets the target brightness to less than the threshold value, the target brightness is less than half the full brightness of the lamp unit 306 and belongs to a second range of target brightness. The inverter control signal 310 is a burst mode pulse signal from which some pulses are omitted. When the command signal 308 is smaller, more pulses of the inverter control signal 310 are omitted. That is to say, the less the command signal 308, the longer the break length of the inverter control signal 310.

When the inverter control signal 310 is a continuous mode pulse signal, the lamp unit control signal 312 generated by the continuous mode inverter 304 is a continuous mode AC signal whose amplitude increases with the duty cycle of the inverter control signal 310. The brightness of the lamp unit 306 increases with the amplitude of the lamp unit control signal 310. When the inverter control signal 310 is a burst mode pulse signal, the lamp unit control signal 312 is a fixed amplitude burst mode AC signal. The amplitude of the lamp unit control signal 312 no longer decreases with the target brightness of the lamp unit 306, but the lamp unit control signal 312 is interrupted by the inverter control signal 310. When more pulses are omitted from the inverter control signal 310, the break length of the lamp unit control signal 312 is longer, and the lamp unit is less bright.

FIG. 3B illustrates the relationship between the command signal 308, the inverter control signal 310 and the lamp unit control signal 312. When the command signal 308 is 100%, the inverter control signal 310 of the continuous mode inverter 304 is a continuous mode pulse signal having a 100% duty cycle (shown as signal 402 of FIG. 3B, which is a DC signal). Signal 412 is the corresponding lamp unit control signal 312 of the signal 402. The signal 412 is a continuous mode AC signal and the lamp unit 306 is at full brightness. Signal 404 shows the inverter control signal 310 corresponding to the command signal 308 lowered to 80%. The duty cycle of the inverter control signal 310 is lowered according to the command signal 308, and the amplitude of the corresponding lamp unit control signal 312 shown as signal 414 is lowered, and the brightness of the lamp unit 306 is lowered. When the command signal is 50%, a threshold value for changing the mode of the inverter control signal 310, signal 406 is the corresponding inverter control signal 310 and signal 416 is the corresponding lamp unit control signal 312. Comparing signal 406 with signal 404, the duty cycle of signal 406 is lower than that of signal 404, and the amplitude of the signal 416 is lower than that of signal 414. The brightness of the lamp unit is half the full brightness. When the command signal 308 is at 30% brightness, signal 408 is the corresponding inverter control signal 310 and signal 418 is the corresponding lamp unit control signal 312. Because the command signal 308 is lower than the threshold value (50%), the signal 408 generated by the control unit 302 is a burst mode pulse signal. As shown in range 422 of the signal 408, 2 pulses are omitted from the inverter control signal 310. The signal 418 generated by the continuous mode inverter 304 based on signal 408 contains break range 424 corresponding to the range 422 of the signal 408. Although the signals 418 and 416 have equivalent amplitude, the brightness of the lamp unit 306 is lowered by the breaks 424 of the signal 418. When the command signal 308 is 10%, signal 410 is the corresponding inverter control signal 310, signal 420 is the corresponding lamp unit control signal 312. As shown in the signal 410, there are 3 pulses omitted from the signal 410. Comparing signal 410 and the signal 420 with signal 408 and signal 418 respectively, more pulses are omitted from signal 410 and the break length of signal 420 is longer than that of signal 418. Because break range 426 is longer than break range 424, the brightness of lamp unit 306 controlled by signal 420 is lower than that controlled by signal 418. This invention has the advantage of both the conventional continuous mode and burst mode inverters (104 and 204). Because the continuous mode inverter 304 is developed from the conventional mode inverter 104, the circuit of the continuous mode inverter of this invention is cheap and simple. Because the continuous mode inverter 304 can be controlled by burst mode AC signals such as the signals 418 and 420, the brightness of the lamp unit 306 can be controlled to a level as low as the level of the conventional burst mode illumination device 200.

The illumination device of the invention can be implemented as the backlight module of the LCD panel or in any application requiring a lamp unit.

The invention further discloses a method of controlling a lamp unit. An inverter control signal is generated based on a command signal. The target brightness of the lamp unit is set by the command signal. When the target brightness is greater than a threshold value, the inverter control signal is a continuous mode pulse signal. The greater the target brightness, the longer the duty cycle of the inverter control signal. When the target brightness is less than the threshold value, the inverter control signal is a burst mode pulse signal. The greater the target brightness, the more pulses are omitted from the inverter control signal. Based on the inverter control signal, a lamp unit control signal is generated to control the brightness of the lamp unit. When the inverter control signal of the continuous mode inverter is a continuous mode pulse signal, the lamp unit control signal is a continuous mode AC signal the amplitude of which increases with the duty cycle of the continuous mode pulse signal. The brightness of the lamp unit increases with the amplitude of the lamp unit control signal. When the inverter control signal of the continuous mode inverter is a burst mode pulse signal, the lamp unit control signal is a burst mode AC signal. The more pulses are omitted from the inverter control signal, the longer the break length of the lamp unit control signal. The brightness of the lamp unit decreases when the break length of the lamp unit control signal increases.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded to the broadest interpretation so as to encompass all such modifications and similar arrangements.

What is claimed is:

1. An illumination device, comprising:
a lamp unit;
a control unit, receiving a command signal to set a target brightness of the lamp unit and generating an inverter control signal, wherein the inverter control signal is a continuous mode pulse signal when the target brightness is in a first range of target brightness, and the inverter control signal is a burst mode pulse signal when the target brightness is in a second range of target brightness; and
a continuous mode inverter, receiving a DC signal, and generating a lamp unit control signal based on the inverter control signal to control the brightness of the lamp unit, wherein the lamp unit control signal is a continuous mode AC signal when the inverter control signal is the continuous mode pulse signal, and the lamp unit signal is a burst mode AC signal when the inverter control signal is the burst mode pulse signal.

2. The illumination device as claimed in claim 1, wherein the control unit further provides a threshold value, and the target brightness belongs to the first range of target brightness when the target brightness is greater than the threshold value, and the target brightness belongs to the second range of target brightness when the target brightness is less the threshold value.

3. The illumination device as claimed in claim 2, wherein the threshold value represents half the full brightness of the lamp unit.

4. The illumination device as claimed in claim 3, wherein the lamp unit is set to full brightness when the duty cycle of the inverter control signal is 100%.

5. The illumination device as claimed in claim 1, wherein the amplitude of the lamp unit control signal increases with the duty cycle of the inverter control signal when the inverter control signal is the continuous mode pulse signal, and the brightness of the lamp unit increases with the amplitude of the lamp unit control signal.

6. The illumination device as claimed in claim 1, wherein the amplitude of the lamp unit control signal decreases with the duty cycle of the inverter control signal when the inverter control signal is the continuous mode pulse signal, and the brightness of the lamp unit decreases with the amplitude of the lamp unit control signal.

7. The illumination device as claimed in claim 1, wherein the break length of the lamp unit control signal varies with the inverter control signal when the inverter control signal is the burst mode pulse signal; the more the pulses in the inverter control signal, the shorter the break length of the lamp unit control signal, and the brighter the lamp unit.

8. The illumination device as claimed in claim 1, wherein the break length of the lamp unit control signal varies with the inverter control signal when the inverter control signal is the burst mode pulse signal; the less the pulses in the inverter control signal, the longer the break length of the lamp unit control signal, and the weaker the brightness of the lamp unit.

9. The illumination device as claimed in claim 1, wherein the lamp unit control signal is an AC voltage or an AC current signal.

10. The illumination device as claimed in claim 1, wherein the DC signal is a DC voltage or a DC current signal.

11. A method of controlling an illumination device, wherein the illumination device comprises a control unit, a continuous mode inverter, and a lamp unit, the method comprising:
generating an inverter control signal based on a command signal, the command signal representing target brightness of the lamp unit, wherein the inverter control signal is a continuous mode pulse signal when the target brightness is in a first range of target brightness, and the inverter control signal is a burst mode pulse signal when the target brightness is in a second range of target brightness; and
receiving a DC signal and generating a lamp unit control signal based on the inverter control signal to control the brightness of the lamp unit, wherein the lamp unit control signal is a continuous mode AC signal when the inverter control signal is the continuous mode pulse signal, and the lamp unit control signal is a burst mode AC signal when the inverter control signal is the burst mode pulse signal.

12. The method as claimed in claim 1 further comprising determining whether the target brightness of the lamp unit is greater than a threshold value, wherein the target brightness belongs to the first range of target brightness when the target brightness is greater than the threshold value, and the target brightness belongs to the second range of target brightness when the target brightness is less than the threshold value.

13. The method as claimed in claim 12, wherein the threshold value represents half the full brightness of the lamp unit.

14. The method as claimed in claim 13, wherein the lamp unit is set to full brightness when the duty cycle of the inverter control signal is 100%.

15. The method as claimed in claim 11, wherein the amplitude of the lamp unit control signal increases with the duty cycle of the inverter control signal when the inverter control signal is the continuous mode pulse signal, and the brightness of the lamp unit increases with the amplitude of the lamp unit control signal.

16. The method as claimed in claim 11, wherein the amplitude of the lamp unit control signal decreases with the duty cycle of the inverter control signal when the inverter control signal is the continuous mode pulse signal, and the brightness of the lamp unit decreases with the amplitude of the lamp unit control signal.

17. The method as claimed in claim 11, wherein the break length of the lamp unit control signal varies with the inverter control signal when the inverter control signal is the burst mode pulse signal; the greater the number of pulses in the inverter control signal, the shorter the break length of the lamp unit control signal, and the brighter the lamp unit.

18. The method as claimed in claim 11, wherein the break length of the lamp unit control signal varies with the inverter control signal when the inverter control signal is the burst mode pulse signal; the fewer the number of pulses in the inverter control signal, the longer the break length of the lamp unit control signal, and the lower the brightness of the lamp unit.

19. The method as claimed in claim 11, wherein the lamp unit control signal is an AC voltage or an AC current signal.

20. The method as claimed in claim 11, wherein the DC signal is a DC voltage or a DC current signal.
